(19) United States
(12) Patent Application Publication
(10) Pub. No.: US 2011/0295547 A1
(43) Pub. Date: Dec. 1, 2011

(54) BODY MOTION DETECTION DEVICE

(75) Inventors: Yuji ASADA, Kyoto-shi (JP); Masahiro KITAGAWA, Kyoto-shi (JP)

(73) Assignee: OMRON HEALTHCARE CO., LTD., KYOTO-SHI (JP)

(21) Appl. No.: 13/184,139

(22) Filed: Jul. 15, 2011

Related U.S. Application Data
(63) Continuation of application No. PCT/JP2009/006454, filed on Nov. 28, 2009.

(30) Foreign Application Priority Data
Feb. 6, 2009 (JP) 2009-026326

(51) Int. Cl. G06F 15/00

(52) U.S. Cl. 702/141; 702/150

(57) ABSTRACT

The invention improves a degree of freedom of a usage mode and improves measurement accuracy. An exercise amount meter main body including an acceleration detection unit for detecting acceleration, and a calculation unit for executing a body motion calculating process for calculating body motion of a living body based on acceleration data, further includes an attachment/detachment guide for allowing a belt type attachment body and a clip type attachment body to be attached or detached, wherein the calculation unit executes an attachment/detachment detection process for detecting attachment or detachment from the change in acceleration that appears in the acceleration data when attaching or detaching the belt type attachment body or the clip type attachment body to or from the attachment/detachment guide, and executes the body motion calculating process based on the detected attachment/detachment while switching to a mode complying with a state after the attachment/detachment.

### TECHNICAL FIELD

The present invention relates to a body motion detection device for detecting body motion of a living body such as a pedometer for counting the number of steps of the living body or an activity amount meter for measuring an activity amount of the living body.

### BACKGROUND ART

Conventionally, various body motion detection devices such as a pedometer and an activity amount meter have been proposed as a device for detecting body motion of a living body. Such body motion detection devices have been proposed to be used by being attached or accommodated in various places.

For example, there has been proposed a pedometer to be attached to a belt at the waist, a chest pocket of the clothes, and the like by clipping with a clip (see Patent Document 1). Such a method of attaching by clipping with the clip has an advantage that stable measurement of the number of steps is enabled since an attachment direction is defined.

However, this method has drawbacks in that it is limited to clothing with areas that can be clipped with the clip and it may affect fashion features of a user since the pedometer stands out.

There has also been proposed a pendulum type exercise amount meter having a wrist watch shape to be attached to the arm with a belt (see Patent Document 2). Such a method of attaching to the arm with the belt has advantages in that the clothing is not limited and that the user can comfortably see the display content.

This method, however, has a problem in that the measurement cannot be carried out unless with an activity in which the arm is strongly swung, and that the application is limited in daily use.

There has also been proposed a body motion detection device that enables the measurement of the number of steps even if the main body is tilted by using a sensor of a plurality of axes, and can be carried around in the pocket of the clothing or the bag (see Patent Document 3). Such a method of using the sensor of a plurality of axes has an advantage of excelling in portability.

This method, however, has a problem of being easily subjected to the influence of various body motions as the measurement in the tilted state is carried out, and it is difficult to respond to a wide range of activities at high accuracy.

Therefore, there are advantages and drawbacks regardless of the attachment form the body motion detection device is used, and the drawbacks cannot be solved with one attachment form.

### Prior Art Documents

### Patent Documents

Patent Document 1: Japanese Unexamined Patent Publication No. 04-080431

Patent Document 2: Japanese Unexamined Patent Publication No. 2002-56372

Patent Document 3: Japanese Unexamined Patent Publication No. 2002-191580

### SUMMARY OF THE INVENTION

### Problems to be Solved by the Invention

In view of the above described problems, an object of the present invention is to improve a degree of freedom of a usage mode and to improve measurement accuracy by detecting in which attachment form use is made and detecting a body motion in a mode suited to the detected attachment form.

### Means for Solving the Problem

In accordance with the present invention, there is provided a body motion detection device including acceleration detection means for detecting acceleration, and calculation means for executing a body motion calculating process of calculating the body motion of a living body based on acceleration data detected by the acceleration detection means, the body motion detection device including an attachment/detachment portion for allowing an attachment body to be attached to the living body or a living body associated article to be attached or detached to or from the device main body, wherein the calculation means is configured to execute an attachment/detachment detection process of detecting attachment or detachment from change in acceleration appearing in the acceleration data when attaching or detaching the attachment body to or from the attachment/detachment portion, and execute the body motion calculating process based on the detected attachment/detachment while switching to a mode complying with a state after the attachment/detachment.

The acceleration detection means may be configured by means capable of detecting the change in acceleration such as an acceleration detection sensor. In the case of the acceleration detection sensor, one-dimensional, two-dimensional, or three-dimensional acceleration sensor may be used, but the three-dimensional acceleration sensor is preferably used.

The body motion calculating process may be a number of steps counting process of counting the number of steps, a life activity amount calculating process of calculating a life activity amount, an arm swing level calculating process of calculating an arm swing level, or a plurality of processes thereof.

The living body associated article includes lower clothes such as pants and a skirt, or a waist belt.

The attachment body is configured by equipment to be attached to the living body or the living body associated article such as a clamping tool including a clip for attaching to the lower clothes such as the pants and skirt or the waist belt, or a belt for attaching to the arm or the leg.

The device main body may be a housing including the acceleration detection means and the calculation means.

The attachment/detachment portion may be configured by an engagement portion such as an appropriate guide, projection, thread, screw groove, hole, or groove to which a predetermined attachment/detachment engaging portion arranged in the attachment body is attached or detached.

The attachment/detachment detection process may be a process of detecting the change in acceleration that occurs in attachment or detachment such as a process of detecting the change in acceleration by collision that occurs when attaching or detaching the attachment body to or from the main body device, a process of detecting the change in acceleration by movement or rotation of the device main body along the guide of the attachment/detachment portion, or a combination thereof.

The mode may be a waist attachment mode, an arm attachment mode, a pocket-in mode, or a plurality of these modes. Upon switching the modes, the body motion to be calculated may be switched from the number of steps, the life activity amount, the arm swing level, or the like, the threshold value to be used in the calculation of the body motion may be switched, or both of the above may be carried out.

The body motion detection device may be an appropriate device such as a pedometer for counting the number of steps, an activity amount meter for calculating the life activity amount, or an exercise amount meter for calculating the number of steps and the life activity amount. The body motion detection device may include output means such as display means and communication means. The acceleration signal or the detected body motion data may be outputted by the output means.

According to the present invention, the attachment or detachment of the attachment body can be detected, and the body motion can be detected in the mode complying with the state after the attachment or detachment. Therefore, the degree of freedom in the usage mode as to which attachment form is used can be improved, and the mode can be switched according to each usage mode thereby improving the measurement accuracy.

In one aspect of the present invention, the attachment/detachment portion may include a collision body to which one part of the attachment body collides in the attachment or detachment of the attachment body, and the attachment/detachment detection process may be configured to detect the change in acceleration that appears when one part of the attachment body collides with the collision body from the acceleration data.

The collision body may be configured with an appropriate site that can collide such as a projection, hole, groove, or wall to which one part of the attachment body collides, and is configured by being integrally formed with the housing of the device main body or by securely attaching a separate member.

One part of the attachment body may be configured with an appropriate site that can collide such as a projection, hole, groove, or wall to which the collision body collides, and may be configured by being integrally formed with the housing of the device main body or by securely attaching a separate member.

According to such an aspect, the change in acceleration that does not appear in the exercise of the living body such as walking, running, arm swing, or life activity can be produced at the attachment or detachment of the device main body and the attachment body, so that the acceleration detection means can accurately detect the attachment or detachment.

In another aspect of the present invention, a plurality of the attachment/detachment portion may be respectively arranged in correspondence with each of a plurality of types of attachment bodies.

The plurality of attachment/detachment portion respectively arranged in correspondence to each of the plurality of types of attachment bodies may be configured so that the attachment and detachment site differs depending on the various types of attachment bodies, for example, being configured using a guide such a rail and a groove in which the attachment/detachment direction is different, or being configured by being arranged in parallel to the same attachment/detachment direction and differing the number and arrangement of the collision body.

According to such a mode, which type of attachment body is attached or detached can be easily detected.

In still another aspect of the present invention, the attachment/detachment detection process is configured to detect the type of attached or detached attachment body by a direction of the change in acceleration that appears when one part of the attachment body collides with the collision body.

Therefore, which type of attachment body is attached or detached can be accurately detected by the direction of the change in acceleration.

In still another aspect of the present invention, the attachment/detachment portion may be configured by differing the number of collision bodies according to the type of the corresponding attachment body, and the attachment/detachment detection process may be configured to detect the type of attached or detached attachment body by the number of change in acceleration that appears when one part of the attachment body collides with the collision body.

Therefore, which type of attachment body is attached or detached can be accurately detected by the number of collisions. In particular, the type of attached or detached attachment body can be more accurately detected by the direction of the change in acceleration and the number of collisions by combining with the configuration of detecting the type of attached or detached attachment body by the direction of the change in acceleration that appears when one part of the attachment body collides with the collision body.

In accordance with the present invention, there may be provided a body motion detection device including acceleration detection means for detecting acceleration, a storage means for storing data, calculation means for executing a body motion calculating process of calculating the body motion of a living body based on acceleration data detected by the acceleration detection means, and display means for displaying the calculation result, the body motion detection device including a plurality of attachment/detachment portions for allowing an attachment body to be attached to the living body or a living body associated article to be attached or detached to or from the device main body according to a type of attachment body, wherein the calculation means is configured to execute an attachment/detachment detection process of detecting attachment or detachment of the attachment body with respect to the attachment/detachment portion and the type of attachment body from change in acceleration that appears in the acceleration data when the attachment body is attached or detached with respect to the attachment/detachment portion, and execute the body motion calculating process based on the detected attachment/detachment and the type while switching to a mode corresponding to the type of attachment body being attached; and the display means is configured to display a screen corresponding to the mode.

The screen corresponding to the mode may be a screen corresponding to the mode including a screen indicating the waist attachment mode, a screen indicating the arm attachment mode, or a screen indicating the pocket-in mode.

According to the present invention, the user can easily check which mode the current mode is.

In one aspect of the present invention, the body motion detection device for detecting body motion of a living body may include an attachment/detachment portion for allowing an attachment body to be attached to the living body or a living body associated article to be attached or detached to or from a device main body, wherein the attachment/detachment portion includes a guide for sliding or rotating the attachment body when the attachment body is attached or detached to or from the device main body, and a collision portion to which one part of the attachment body collides in the attachment or detachment of the attachment body along the guide.

The guide may be configured with a member for regulating the slide or the rotation of when attaching or detaching the attachment body such as a rail, groove, thread, or screw groove.

According to the present invention, the relative movement of the device main body and the attachment body at the time of attachment or detachment can be defined, and the detection of attachment or detachment can be facilitated.

In accordance with the present invention, there may be provided an input device including acceleration detection means for detecting acceleration, calculation means for executing a calculation based on the acceleration data detected by the acceleration detection means, and a housing for accommodating the acceleration detection means and the calculation means, wherein the housing includes a collision body to be applied with an impact by collision, and the calculation means is configured to detect impact acceleration data in which change in acceleration occurs by the impact applied on the collision body from the acceleration data, detect impact content in which the impact is applied from the acceleration data, and execute an input information determining process of determining the information inputted by the impact content.

The impact content may be at least one of a direction, the number of times, an interval, and intensity of the impact.

The inputted information may be appropriate information such as mode switching information for switching the modes, or input instructing information indicating a predetermined input instruction. The input device may include output means (display means, communication means, and the like) for outputting the determined input information.

The impact acceleration data may be acceleration data obtained from the change in acceleration that occurs when the impact is applied on the collision body. Therefore, the impact acceleration data and normal acceleration data indicating the change in acceleration that occurs from operations such as oscillating, moving, or rotating the entire input device coexist in the acceleration data detected by the acceleration detection means.

According to the present invention, the input information can be determined from the impact on the collision body. In particular, if the input device is adopted to the body motion detection device, the input other than the body motion detection can be detected in addition to the body motion detection by the acceleration detection means.

In accordance with the present invention, there may be provided a body motion detection method of detecting body motion of a living body from acceleration data indicating change in acceleration caused by the body motion of the living body, the body motion detection method including the steps of detecting change in acceleration that occurs when an attachment body is attached or detached with respect to a device main body from the acceleration data, and detecting the body motion from the acceleration data of after attachment or detachment by a body motion detection process of a mode corresponding to a state after the attachment or detachment.

Therefore, the attachment or detachment of the attachment body can be detected from the acceleration data, and the body motion can be detected in the mode corresponding to the attachment or detachment state of the attachment body from the acceleration data after the attachment or detachment.

Therefore, a separate information processing device (computer, portable information terminal, server, or the like) may receive the acceleration data from the body motion detection holding device including the acceleration detection means and the data transmission means, and the body motion may be detected in such an information processing device.

In this case, use can be made in various forms, for example, the server may receive the acceleration data and accurately detect the body motion from the acceleration data, or an instructor who gives advice on exercises may check the body motion accurately detected by the information processing device and give advice on the user who is exercising.

### EFFECT OF THE INVENTION

According to the present invention, in which attachment form use is made can be detected and the body motion can be detected in the mode suited to the detected attachment form to improve the degree of freedom of the usage mode and improve the measurement accuracy. In particular, the attachment form is detected by combining the hardware configuration of the attachment/detachment portion and the software process, so that the attachment form can be reliably detected with a simple configuration.

### BRIEF DESCRIPTION OF THE DRAWINGS

FIG. 1 is an exploded perspective view of an exercise amount meter seen from a front surface side.

FIG. 2 is an exploded perspective view of the exercise amount meter seen from a rear surface side.

FIGS. 3(A1) to 3(C2) are explanatory views describing each state of the exercise amount with perspective views.

FIG. 4 is a block diagram showing a configuration of the exercise amount meter.

FIG. 5 is a flowchart of the operation by an overall program.

FIGS. 6(A) and 6(B) are explanatory views describing attachment and detachment of the attachment body with enlarged cross-sectional views.

FIG. 7 is a graph showing a waveform of acceleration data.

FIG. 8 is a flowchart of the operation by a waist attachment body detection program.

FIG. 9 is a flowchart of the operation by an arm attachment body detection program.

FIG. 10 is a flowchart of the operation by a pocket-in body motion detection program.

FIGS. 11(A) and 11(B) are explanatory views describing another configuration with perspective views.

FIG. 12 is an exploded perspective view of an exercise amount meter of a second example viewed from the front surface side.

FIG. 13 is an exploded perspective view of the exercise amount meter of the second example viewed from the rear surface side.

FIG. 14 is a perspective view of an exercise amount meter main body of the second example seen from the rear surface side.

FIGS. 15(A) to 15(C) are explanatory views describing the attachment/detachment operation of the clip type attachment body of the second example.

FIGS. 16(A) to 16(D) are explanatory views describing the attachment/detachment operation of the belt type attachment body of the second example.

### MODE FOR CARRYING OUT THE INVENTION

One embodiment of the present invention will be described below with reference to the drawings.

### First Example

In a first example, there will be described an exercise amount meter corresponding to three modes, i.e., an arm attachment mode of being attached to the arm for use, a waist attachment mode of being attached to the waist for use, and a pocket-in mode of being accommodated in a pocket for use.

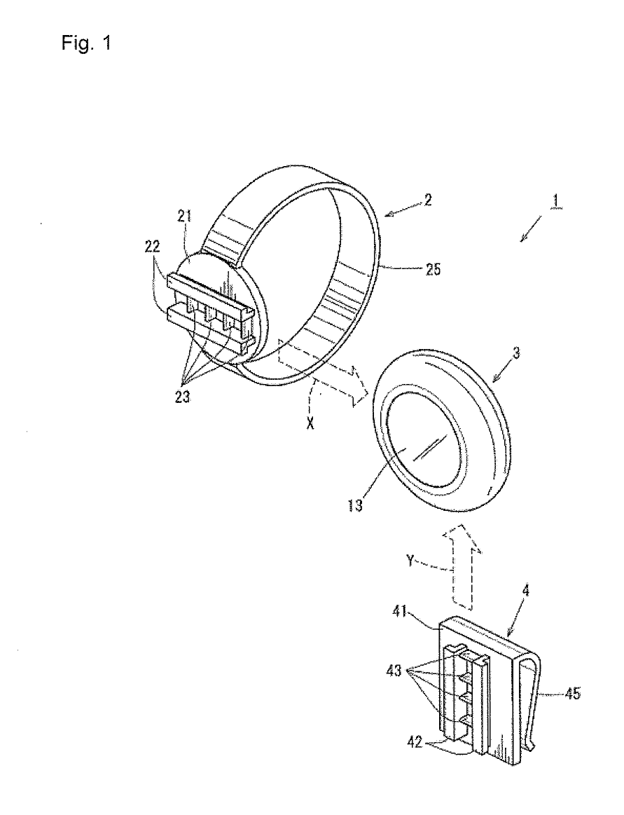

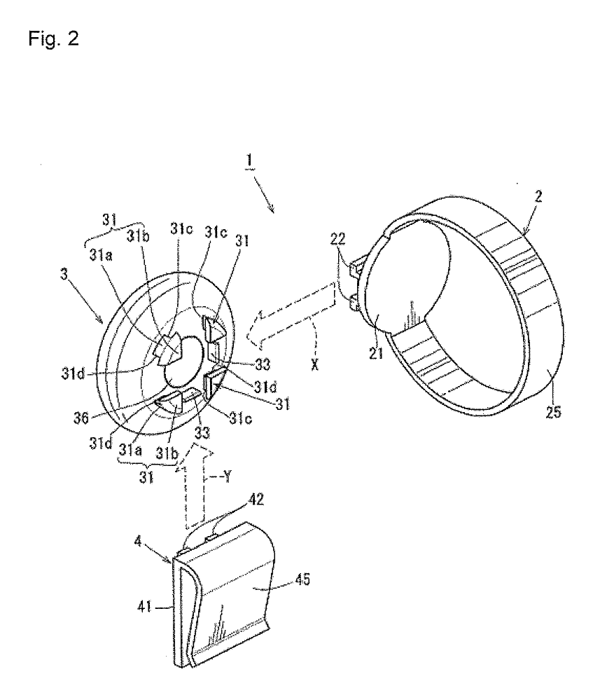

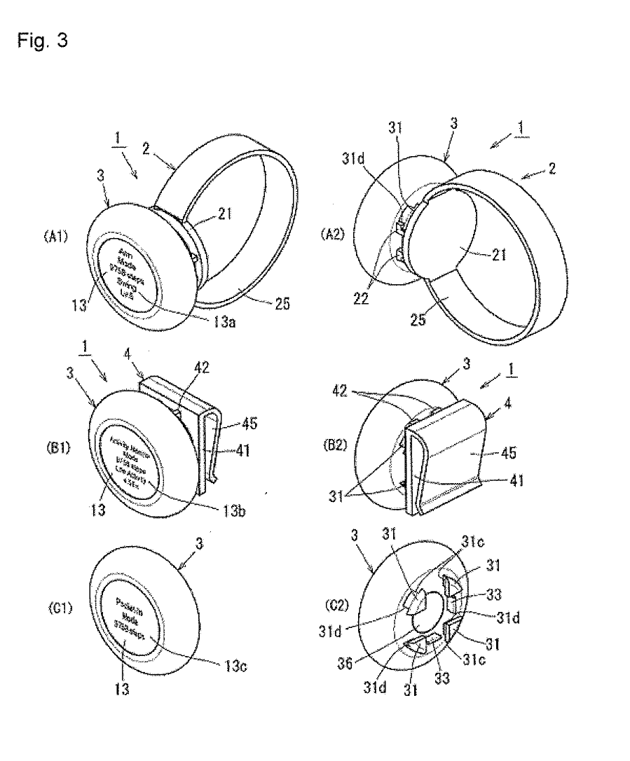

FIG. 1 shows an exploded perspective view of an exercise amount meter 1 seen from the front surface side, FIG. 2 shows an exploded perspective view of the exercise amount meter 1 seen from the rear surface side, and FIGS. 3(A1) to 3(C2) shows explanatory views describing each state of the exercise amount meter 1 with perspective views.

The exercise amount meter 1 is configured by an exercise amount meter main body 3, and a belt type attachment body 2 as well as a clip attachment body 4 attachable and detachable to the exercise amount meter main body 3.

The exercise amount meter main body 3 is formed in a thick substantially disc shape in the illustrated example, where a display unit 13 is arranged on the front surface as shown in FIG. 1, four attachment/detachment guides 31 and two collision projections 33, and one back lid 36 are arranged on the rear surface as shown in FIG. 2.

The attachment/detachment guides 31 are equally arranged at four areas at positions equidistant from the center of the back surface of the exercise amount meter main body 3, and are all formed in the same shape. Each attachment/detachment guide 31 is formed in a substantially triangular prism shape of two stages in which an outer peripheral size of a distal end 31b is greater than an outer peripheral size of a basal end 31a fixed to the back surface of the exercise amount meter main body 3. A space between the distal end 31b and the back surface of the exercise amount meter main body 3 thus functions as the clip guide recess 31c and the band guide recess 31d at the side surface of the basal end 31a.

One spatial position of clip guide recesses 31c, 31c and one spatial position of band guide recesses 31d, 31d include each collision projection 33, 33 for clip and for band.

The back lid 36 is an openable/closable lid for accommodating a battery, and is arranged at the middle of the rear surface of the exercise amount meter main body 3. The back lid 36 cannot be opened if the belt type attachment body 2 and the clip type attachment body 4 are attached to the exercise amount meter main body 3 covering the exercise amount meter main body 3, and can be opened only if the belt type attachment body 2 and the clip type attachment body 4 are detached from the exercise amount meter main body 3. Therefore, when changing a battery, the exercise amount meter main body 3 must be in a singular state not attached with the attachment body (2, 4).

The belt type attachment body 2 is configured by a ring shaped belt portion 25 for attaching to the arm of the user, and a mount portion 21, arranged at one part of the belt portion 25, for attaching and detaching the exercise amount meter main body 3 on the outer side.

As shown in FIG. 1, the mount portion 21 includes guide rails 22, 22 configured by two parallel rails at the surface on the outer side, and a plurality of protruding ribs 23 bridged between the guide rails 22, 22 are arranged in multi-stages in an attachment direction (direction of arrow X)

The rib 23 is formed in a rod shape or a plate shape that is at a right angle with respect to the attachment/detachment direction of the exercise amount meter main body 3 by the guide rail 22, and parallel to the opposing surfaces of the exercise amount meter main body 3 and the mount portion 21. A plurality of ribs 23 are arranged within a movement distance in which the guide rail 22 engages with the band guide recess 31d of the exercise amount meter main body 3 and slidably moves at the time of attachment or detachment. The rib 23 thus functions as an attachment body side collision body and the collision projection 33 serving as a main body side collision body arranged in the exercise amount meter main body 3 comes into collision with the plurality of ribs 23 during the slidable movement. The two guide rails 22 and the plurality of ribs 23 form a ladder like shape.

The clip type attachment body 4 is configured by a mount portion 41 for attaching and detaching the exercise amount meter main body 3, and a clip portion 45 for sandwiching the belt, pants, skirt, or the like of the user at the back surface side of the mount portion 41.

As shown in FIG. 1, the mount portion 41 includes guide rails 42, 42 configured by two parallel rails at the outer side surface, and a plurality of protruding ribs 43 bridged between the guide rails 42, 42 are arranged in multi-stages in the attachment direction (direction of arrow Y).

The rib 43 is formed in a rod shape or a plate shape that is at a right angle with respect to the attachment/detachment direction of the exercise amount meter main body 3 by the guide rail 42, and parallel to the opposing surfaces of the exercise amount meter main body 3 and the mount portion 41. The plurality of ribs 43 are arranged within a movement distance in which the guide rail 42 engages with the clip guide recess 31 c of the exercise amount meter main body 3 and slidably moves at the time of attachment or detachment. The rib 43 thus functions as an attachment body side collision body and the collision projection 33 of the exercise amount meter main body 3 comes into collision with the plurality of ribs 43 during the slidable movement. The two guide rails 42 and the plurality of ribs 43 form a ladder like shape.

According to such a configuration, the exercise amount meter main body 3 can take three modes, i.e., being used as an arm attachment type by attaching the belt type attachment body 2 as shown in FIGS. 3(A1), 3(A2), used as a waist attachment type by attaching the clip type attachment body 4 as shown in FIGS. 3(B1), 3(B2), or used as a pocket-in type without attaching either the belt type attachment body 2 nor the clip type attachment body 4 as shown in FIGS. 3(C1), 3(C2).

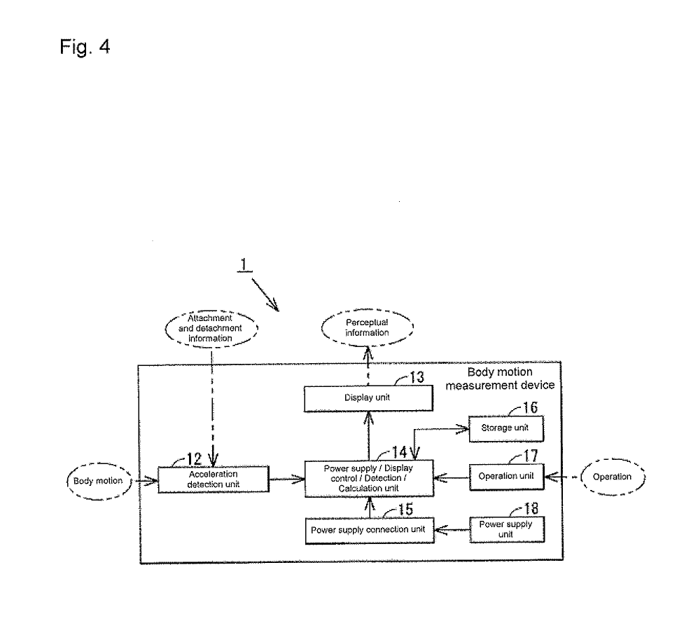

FIG. 4 is a block diagram showing a configuration of the exercise amount meter 1.

The exercise amount meter 1 includes an acceleration detection unit 12, a display unit 13, a calculation unit 14, a power supply connection unit 15, a storage unit 16, an operation unit 17, and a power supply unit 18, and is formed in a size of an extent that can be fitted inside the palm of a normal person so as to be portable.

The acceleration detection unit 12 is a sensor for detecting acceleration of a vibration generated by walking, body motion, or the like of the user wearing the exercise amount meter 1, and transmits a detection signal to the calculation unit 14. The acceleration detection unit 12 is configured by a three-dimensional acceleration sensor for detecting acceleration in three orthogonal directions. The acceleration detection unit 12 is arranged in the exercise amount meter main body 3 with three directions to be detected correctly aligned to the front and back direction, the left and right direction, and the up and down direction of the exercise amount meter main body 3. Therefore, each acceleration component in the front and back direction, the left and right direction, and the up and down direction can be easily and accurately detected. Furthermore, the band guide recess 31d (see FIG. 2) is formed so as to slide in parallel to the left and right direction, and the clip guide recess 31c (see FIG. 2) is formed so as to slide in parallel to the up and down direction, so that attachment and detachment of the belt type attachment body 2 and the clip type attachment body 4 can also be accurately detected.

The display unit 13 is configured by a display device such as a liquid crystal, and displays information according to a display control signal from the calculation unit 14. The displaying information may be information related to the exercise amount such as the number of steps, a life activity amount, an arm swinging level, and a current mode.

The calculation unit 14 is driven by power received from the power supply unit 18 through the power supply connection unit 15, and executes the reception (detection) of the detection signal transmitted from the acceleration detection unit 12 and the operation unit 17, and the supply of power (power supply) as well as the operation control (display control) with respect to the display unit 13 and the storage unit 16. The calculation unit 14 also executes the process of calculating with reference to walking criterion data and one-step criterion data stored in the storage unit 16 based on the detection signal transmitted from the acceleration detection unit 12.

The storage unit 16 stores necessary program and data such as acceleration data that is a detection signal detected by the acceleration detection unit 12, an overall program for detecting attachment or detachment of the belt type attachment body 2 and the clip type attachment body 4 from the acceleration data and switching the measurement modes, an arm attachment body motion detection program executed when the belt type attachment body 2 is attached, a waist attachment body motion detection program executed when the clip type attachment body 4 is attached, a pocket-in body motion detection program executed when the belt type attachment body 2 nor the clip type attachment body 4 is attached, an arm attachment mode parameter used in the arm attachment body motion detection program, a waist attachment mode parameter used in the waist attachment body motion detection program, a pocket-in mode parameter used in the pocket-in body motion detection program, and the calculated number of steps as well as activity amount other than walking.

The operation unit 17 accepts an appropriate operation input such as input operation of the user information including weight and length of stride, date and time input operation for setting time, and display content switching operation for switching the display content to various types of contents such as the number of steps, consumed calories, and walking distance, and transmits the operation input signal to the calculation unit 14.

The power supply unit 18 is configured by an appropriate power supply that can be carried around such as a chargeable battery or an unchargeable battery.

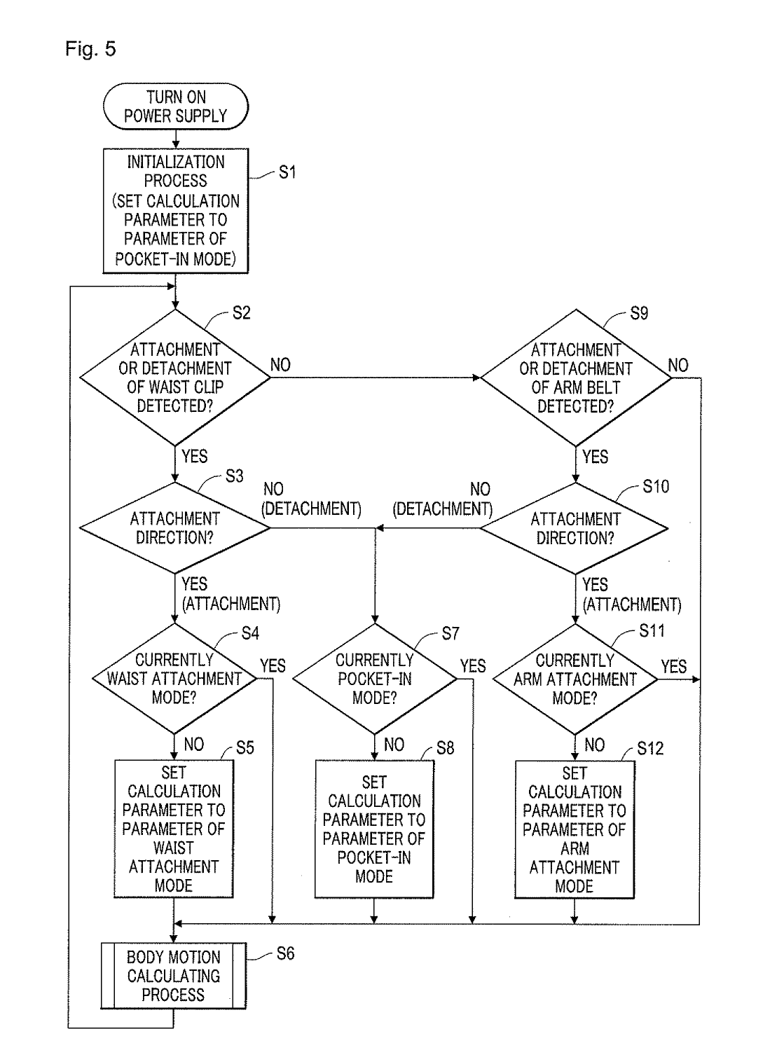

FIG. 5 is a flowchart showing the operations executed by the calculation unit 14 of the exercise amount meter 1 according to the overall program stored in the storage unit 16.

The calculation unit 14 executes an initialization process in response to turning ON the power supply (attachment of battery) (step S1). In the initialization process, the process for setting the calculation parameter to the pocket-in mode parameter is also executed. After the initialization process is completed, the calculation unit 14 executes various processes (steps S2 to S12) with respect to the acceleration data detected by the acceleration detection unit 12.

The calculation unit 14 detects the presence of attachment or detachment of the clip attachment body 4 based on the acceleration data detected by the acceleration detection unit 12 (step S2).

The presence of attachment or detachment of the clip type attachment body 4 is detected from change in acceleration that appears when the rib 43 of the clip type attachment body 4 comes into collision with the collision projection 33 of the exercise amount meter main body 3 when the clip type attachment body 4 is attached or detached to or from the exercise amount meter main body 3.

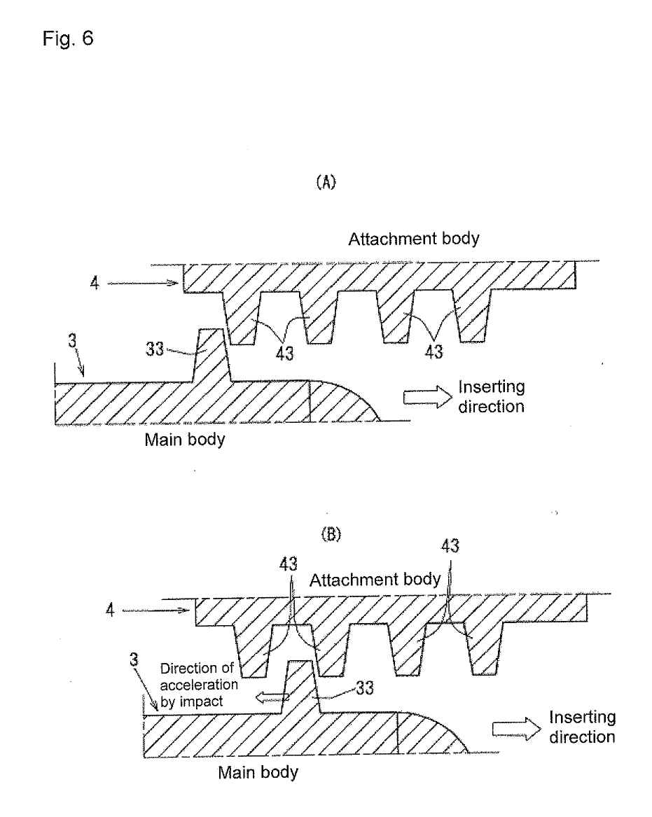

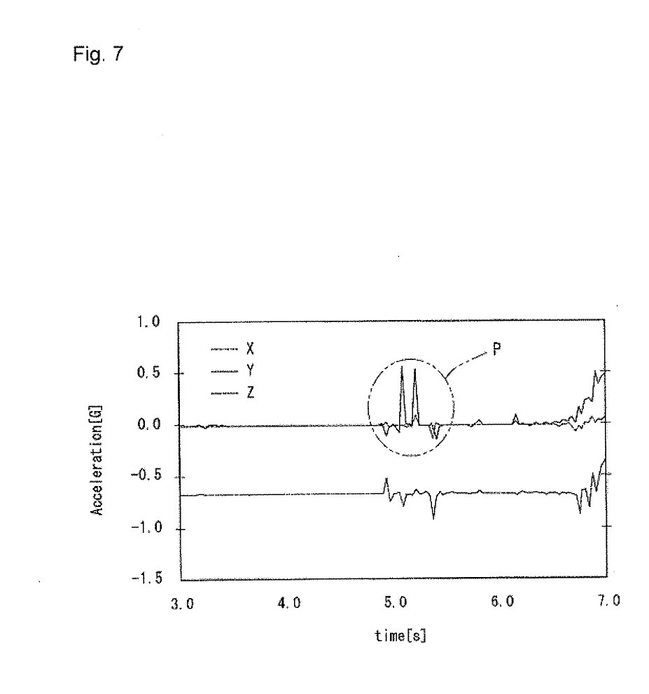

Specifically describing, for example, when attaching the clip type attachment body 4, if the clip type attachment body 4 and the exercise amount meter main body 3 are slidably moved as shown in FIG. 6(A), the collision projection 33 of the exercise amount meter main body 3 goes over the rib 43 while coming into collision with the rib 43 of the clip type attachment body 4, as shown in FIG. 6(B). When going over while coming into collision, a sharp waveform P (waveform in which an intensity of a predetermined range appears within a predetermined time) projecting only to one side (positive direction in the illustrated example) in the Y direction (up and down direction of the exercise amount meter main body 3) appears according to the number of times the collision projection 33 comes into collision with the rib 43, as shown in the graph of FIG. 7. The sharp waveform that projects out only to one positive or negative side is a waveform that does not appear in normal walking, life activity, or arm swing, and it is apparent that such a waveform is a result of attachment or detachment and not of exercise. Thus, by detecting such a waveform, the calculation unit 14 can detect the attachment or detachment of the clip type attachment body 4.

When the attachment or detachment of the clip type attachment body 4 is detected (step S2: Yes), the calculation unit 14 determines whether or not such attachment or detachment is the attachment direction (positive direction) (step S3). The calculation unit 14 that determines the attachment direction determines as attachment if the waveform P detected by the acceleration detection unit 12 is positive (upward) in the Y direction (up and down direction) and as detachment if the waveform P is negative (downward).

If determined as the attachment direction (attachment) (step S3: Yes), the calculation unit 14 determines whether or not the current mode is the waist attachment mode (step S4).

If not determined as the waist attachment mode (step S4: No), the calculation unit 14 sets the calculation parameter to the waist attachment mode parameter (step S5). In this case, the calculation unit 14 switches the program for calculating the body motion to the waist attachment body motion detection program, and completely transitions to the waist attachment mode. By steps S4 and S5, the mode is transitioned to the waist attachment mode immediately after the clip type attachment body 4 is attached to the exercise amount meter main body 3.

The calculation unit 14 uses the set parameter and executes the body motion calculating process with the switched body motion detection program (step S6), and returns the process to step S2 and repeats the process. The details of the body motion calculating process will be hereinafter described for each mode.

If determined as the waist attachment mode in step S4 (step S4: Yes), the calculation unit 14 executes the body motion calculating process (step S6) as is.

If attachment or detachment is not in the attachment direction (positive direction) in step S3 (step S3: No), determination is made as detachment, and thus the calculation unit 14 determines whether or not the current mode is the pocket-in mode (step S7).

If determined not as the pocket-in mode (step S7: No), the calculation unit 14 sets the calculation parameter to the pocket-in mode parameter, switches the body motion detection program to the pocket-in body motion detection program (step S8), and proceeds the process to step S6.

If determined as the pocket-in mode (step S7: Yes), the calculation unit 14 proceeds the process to step S6. By steps S7 and S8, the mode is immediately returned to the pocket-in mode when the clip type attachment body 4 is detached from the exercise amount meter main body 3.

If attachment or detachment of the clip type attachment body 4 is not detected in step S2 (step S2: No), the calculation unit 14 executes the detection of the attachment or detachment of the belt type attachment body 2 (step S9). This attachment or detachment is detected by whether or not the sharp waveform P described above (see FIG. 7) appears in the X direction (left and right direction).

If attachment or detachment is not detected (step S9: No), the mode does not need to be changed, and hence the calculation unit 14 proceeds the process to the body motion calculating process (step S6).

If the attachment or detachment of the belt type attachment body 2 is detected (step S9: Yes), the calculation unit 14 determines whether or not such attachment or detachment is in the attachment direction (positive direction) (step S10). The calculation unit 14 that makes the determination on the attachment direction determines as attachment if the waveform P detected in the acceleration detection unit 12 is positive (leftward in rear view) in the X direction (left and right direction), and as detachment if the waveform P is negative (rightward in rear view).

Since determination is made as detachment unless the attachment or detachment is in the attachment direction (positive direction) (step S10: No), the calculation unit 14 executes steps S7 to S8, changes the mode to the pocket-in mode, and proceeds the process to the body motion calculating process (step S6).

If the attachment or detachment is in the attachment direction (attachment) (step S10: Yes), the calculation unit 13 determines whether or not the current mode is the arm attachment mode (step S11).

If determined not as the arm attachment mode (step S11: No), the calculation unit 14 sets the calculation parameter to the arm attachment mode parameter (step S12), and proceeds the process to the body motion calculating process (step S6).

When setting to the arm attachment mode parameter, the calculation unit 14 also switches the program for calculating the body motion to the arm attachment body motion detection program, and completely transitions to the arm attachment mode. By steps S11 and S12, the mode is transitioned to the arm attachment mode immediately after the belt type attachment body 2 is attached to the exercise amount meter main body 3.

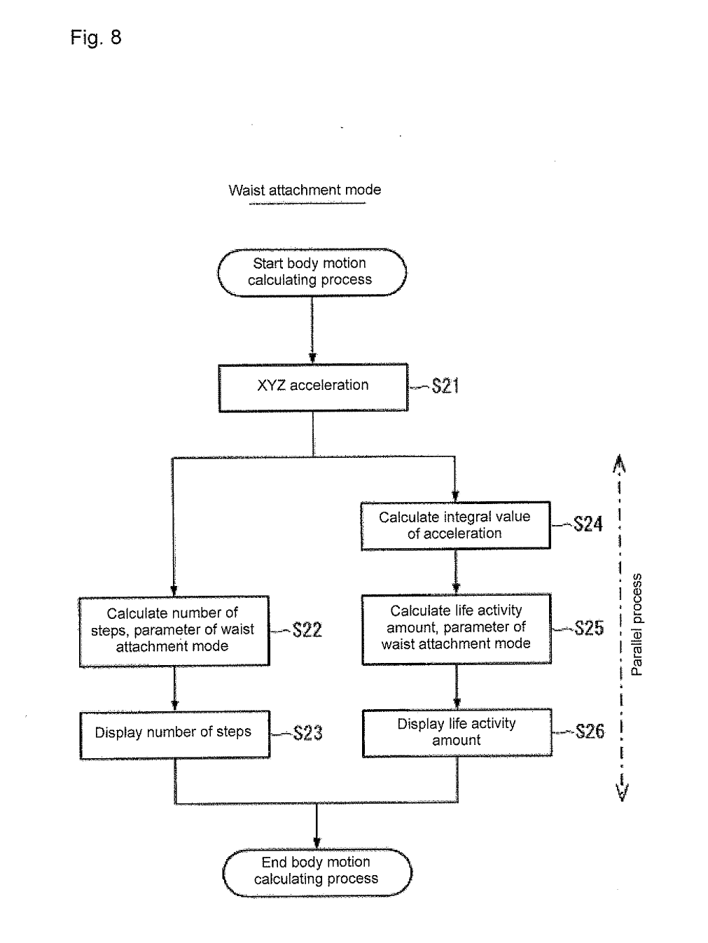

FIG. 8 is a flowchart showing the operation of the calculation unit 14 for executing the body motion calculating process according to the waist attachment body motion detection program in the waist attachment mode.

The calculation unit 14 acquires acceleration data of XYZ acceleration detected in the three-dimensional acceleration detection unit 12 (step S21). Thereafter, the calculation unit 14 processes the number of steps counting process (steps S22 and S23) and the life activity amount calculating process (steps S24 to S26) in parallel.

The calculation unit 14 for executing the number of steps counting process calculates the number of steps from the acceleration data (step S22). In this case, the calculation unit 14 calculates the number of steps using the waist attachment mode parameter. The number of steps can be accurately detected since the number of steps can be counted with the parameter suited for the state of being attached to the waist.

The calculation unit 14 displays the calculated number of steps on the display unit 13 as a waist attachment mode display screen 13b (step S23), and terminates the body motion calculating process. The waist attachment mode display screen 13b in this case preferably displays “Activity Monitor Mode” indicating the waist attachment mode, “9758 steps” indicating the total number of steps for today, “Life Activity 4.5 Ex” indicating the total life activity amount for today, and the like, as shown in FIG. 3(B1). Since the number of steps is counted at this time point, the already obtained total life activity amount for today is displayed as is for the life activity amount.

The calculation unit 14 for executing the life activity amount calculating process calculates an integrated value of the acceleration (step S24), and calculates the life activity amount (step S25). In this case, the calculation unit 14 calculates the life activity amount using the waist attachment mode parameter. The life activity amount can be accurately calculated since the life activity amount can be calculated with the parameter suited to the state of being attached to the waist.

The calculation unit 14 displays the calculated life activity amount on the display unit 13 (step S26), and terminates the body motion calculating process. The display in this case may be the same as the display described in step S23.

The process of determining whether or not the walking data may be executed after step S21. The determination on whether or not the walking data is executed by a reference of whether the local maximal value and the local minimal value of the acceleration data are within a predetermine threshold value range, appear at a period of a predetermined range, or continue for a predetermined number or more. After the determination, the number of steps counting process is performed if determined as walking, and the life activity amount calculating process is performed if not the number of steps. If configured in such a manner, the calculation unit 14 can selectively execute either one of the number of steps counting process and the life activity amount calculating process.

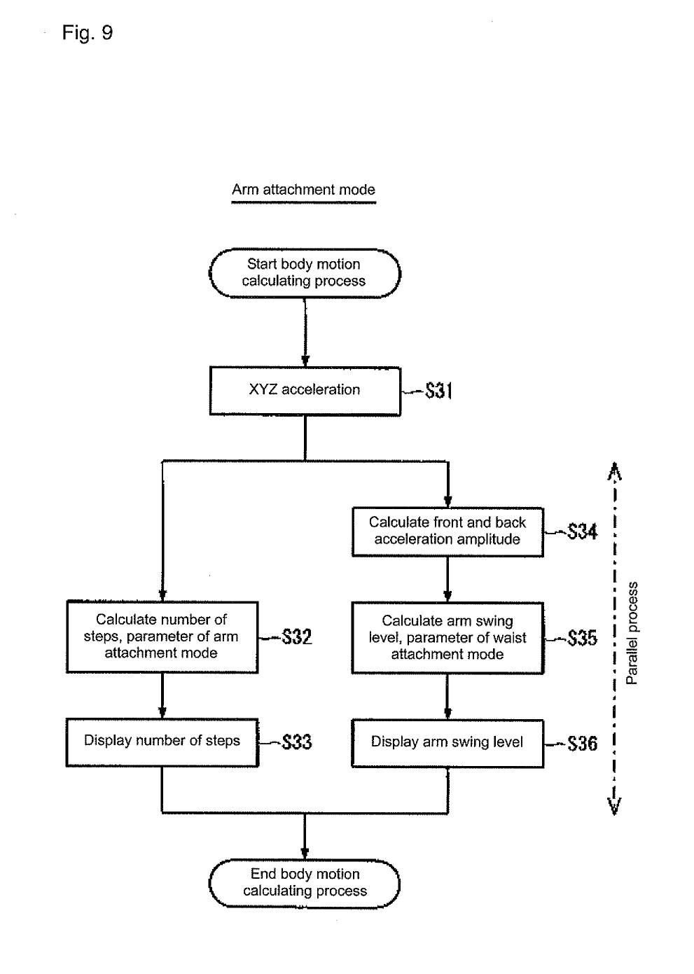

FIG. 9 is a flowchart showing the operation of the calculation unit 14 for executing the body motion calculating process according to the arm attachment body motion detection program in the arm attachment mode.

The calculation unit 14 acquires the acceleration data of the XYZ acceleration detected in the three-dimensional acceleration detection unit 12 (step S31). Thereafter, both the number of steps counting process (steps S32 and S33) and the arm swing level calculating process (steps S34 to S36) are processed in parallel, and both the number of steps and the arm swing level are obtained from one acceleration data. The number of steps counting process (steps S32 and S33) and the arm swing level calculating process (steps S34 to S36) are not limited to the parallel process, and may be sequentially executed. Even if the processes are sequentially executed, the object can be achieved by calculating the number of steps and the arm swing level both from one acceleration data.

The calculation unit 14 for performing the number of steps counting process calculates the number of steps from the acceleration data (step S32). in this case, the calculation unit 14 calculates the number of steps using the arm attachment mode parameter. The number of steps can be accurately detected since the number of steps can be counted with the parameter suited to the state of being attached to the arm.

The calculation unit 14 displays the calculated number of steps on the display unit 13 as an arm attachment mode display screen 13a (step S33), and terminates the body motion calculating process. The arm attachment mode display screen 13a in this case may display “Arm Mode” indicating the arm attachment mode, “9758 steps” indicating the total number of steps for today, “Swing Lv.5” indicating the current arm swing level, and the like, as shown in FIG. 3(A1).

The calculation unit 14 for performing the arm swing level calculating process calculates the amplitude of the acceleration in the front and back direction (Z direction) (step S34), and calculates the arm swing level (step S35). In this case, the calculation unit 14 calculates the arm swing level using the arm attachment mode parameter. The arm swing level can be accurately calculated since the arm swing level can be calculated with the parameter suited to the state of being attached to the arm.

The calculation unit 14 displays the calculated arm swing level on the display unit 13 (step S36), and terminates the arm swing level calculating process. The display in this case may be the same as the display described in step S33.

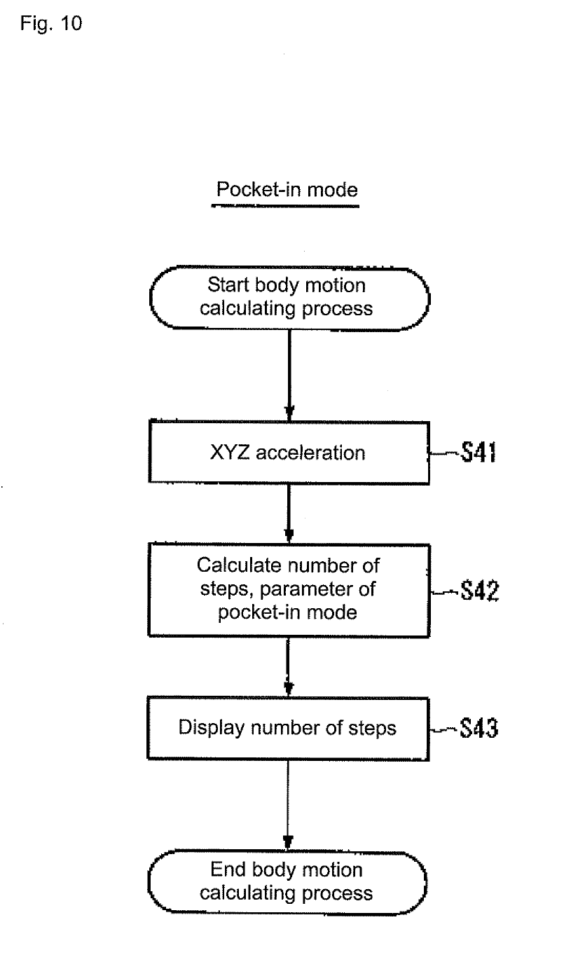

FIG. 10 is a flowchart showing the operation of the calculation unit 14 for executing the body motion calculating process according to the pocket-in body motion detection program in the pocket-in mode.

The calculation unit 14 acquires the acceleration data of the XYZ acceleration detected in the three-dimensional acceleration detection unit 12 (step S41). Thereafter, the number of steps counting process (steps S42 and S43) are executed, and the number of steps is obtained from one acceleration data.

The calculation unit 14 for performing the number of steps counting process calculates the number of steps from the acceleration data (step S42). In this case, the calculation unit 14 calculates the number of steps using the pocket-in mode parameter. The number of steps can be accurately detected since the number of steps can be counted with the parameter suited to the state of being accommodated in the pocket.

The calculation unit 14 displays the calculated number of steps on the display unit 13 as a pocket-in mode display screen 13c (step S43), and terminates the body motion calculating process. As shown in FIG. 3(C1), the pocket-in mode display screen 13c in this case may display “Pocket-in Mode” indicating the pocket-in mode, “9758 steps” indicating the total number of steps for today, and the like.

According to the above configuration and operation, the exercise amount meter 1 can detect with which attachment form it is to be used, and can detect the body motion in the mode suited to the detected attachment form. The conflicting problems of improving the degree of freedom of the usage mode and improving the measurement accuracy can be satisfied.

Since the mode is switched when the attachment body (belt type attachment body 2, clip type attachment body 4) is attached or detached, the mode can be automatically switched in cooperation with the change in the attachment form without the user performing the manual input operation of mode switching or the like. Therefore, the mode can be prevented from not being correctly switched when the manual input operation is forgotten, so that the mode can be reliably switched to the mode corresponding to the attachment form. Thus, the number of steps, the activity amount, and the arm swing level can be reliably and accurately detected.

The exercise amount meter 1 can be inexpensively and compactly manufactured since the switching of the attachment form can be detected using the acceleration detection unit 12 for measuring the exercise amount such as the number of steps, the activity amount, and the arm swing level.

If the mode switching is detected with a detection device different from the acceleration detection unit 12, the exercise amount may be measured without the mode being correctly switched when only the other detection device breaks down thus causing drawbacks in which the breakdown is not noticed. However, such drawbacks can be prevented since the exercise amount meter 1 also detects the mode switching by the acceleration detection unit 12.

The exercise amount meter main body 3 separately includes the band guide recess 31d for the belt type attachment body 2 and the clip guide recess 31c for the clip type attachment body 4, so as to easily and reliably detect which of the belt type attachment body 2 and the clip type attachment body 4 is attached or detached.

The exercise amount meter 1 can detect the direction of the change in the acceleration that appears when the collision projection 33 and the ribs 23, 43 collide, so that the type of the attached or detached attachment body can be detected. Therefore, whether the belt type attachment body 2 or the clip type attachment body 4 is attached or detached can be reliably detected.

The detection of the reliable attachment or detachment can be executed with a simple configuration since the collision projection 33 and the ribs 23, 43 are arranged in a mode of being collided when attaching or detaching the belt type attachment body 2 or the clip type attachment body 4 with respect to the exercise amount meter main body 3.

The lowering of the waterproof property can be prevented since the pushing button for manual input operation to carry out mode switching with the manual input is not necessary.

Since a characteristic waveform is obtained by the collision of the collision projection 33 and the ribs 23, 43, the calculation load of the software process required for the detection of attachment or detachment can be reduced and the detection accuracy can be improved.

The overall shape of the exercise amount meter 1 can be miniaturized since the hardware configuration for using the collision in the detection of attachment or detachment is realized with a small projection or the like.

Therefore, the exercise amount meter 1 can obtain various effects by combining the hardware configuration of using the collision projection 33 and the ribs 23, 43, and the software process of detecting the change in acceleration that appears by the collision.

In the example described above, the same number of ribs 23, 43 is provided, but the number of ribs 23 and ribs 43 may be differed. In this case, the number of change in acceleration that appears when the ribs 32, 43 collide against the collision projection 33 is detected by the acceleration detection unit 12, and according to this number, whether the rib 23 collided by the attachment or detachment of the belt type attachment body 2 or the rib 43 collided by the attachment or detachment of the clip type attachment body 4 may be detected. In this case as well, whether the attached or detached body is the belt type attachment body 2 or the clip type attachment body 4 can be reliably detected.

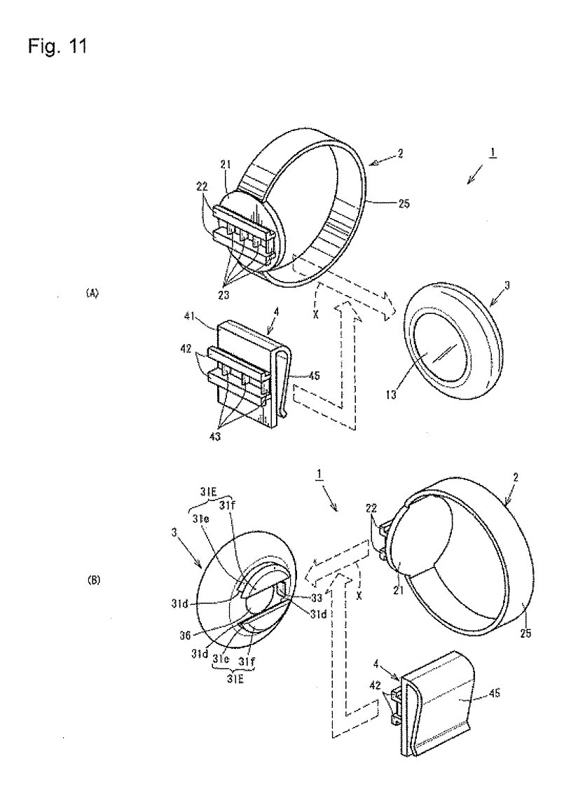

In the clip guide recess 31c and the band guide recess 31d described in FIGS. 1 and 2, only one of the band guide recess 31d may be arranged as shown in FIGS. 11(A) and 11(B), and the belt type attachment body 2 and the clip type attachment body 4 may be attached or detached to the same place.

In this case, a basal end 31e and a distal end 31f of an attachment/detachment guide 31E are formed horizontally longer than the basal end 31 and the distal end 31 of the above described attachment/detachment guide 31 (see FIG. 2), as shown in the perspective view seen from the front surface side of FIG. 11(A) and the perspective view seen from the rear surface side of FIG. 11(B).

The collision projection 33 may be arranged on the exercise amount meter main body 3, and the number of ribs 23 (four in the illustrated example) arranged in the belt type attachment body 2 and the number of ribs 43 (three in the illustrated example) arranged in the clip type attachment body 4 may be differed. In this case as well, which of the belt type attachment body 2 and the clip type attachment body 4 is attached or detached can be detected by the number of collisions between the collision projection 33 and the ribs 23, 43, and whether it is the attachment or detachment can be detected by the direction of impact caused by the collision.

### Second Example

An exercise amount meter 1A of the second example having a different structure for detecting attachment or detachment will now be described.

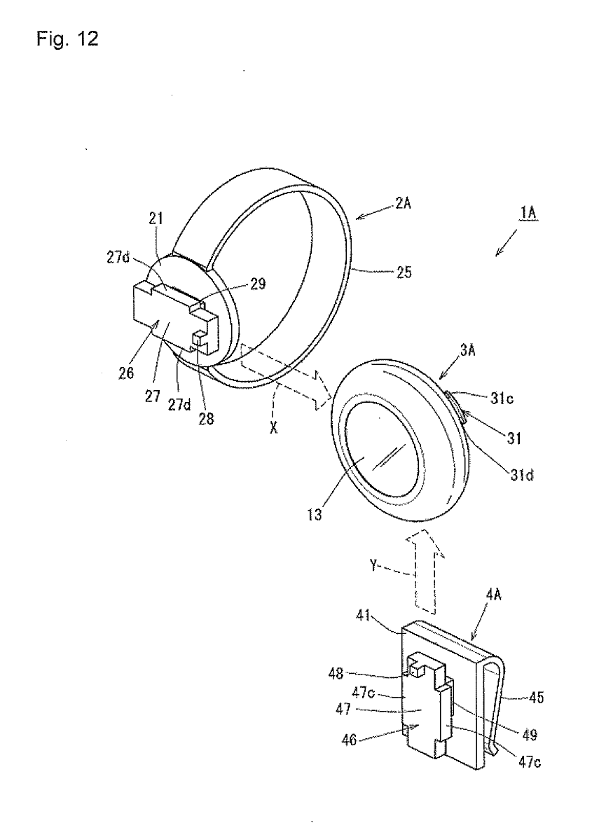

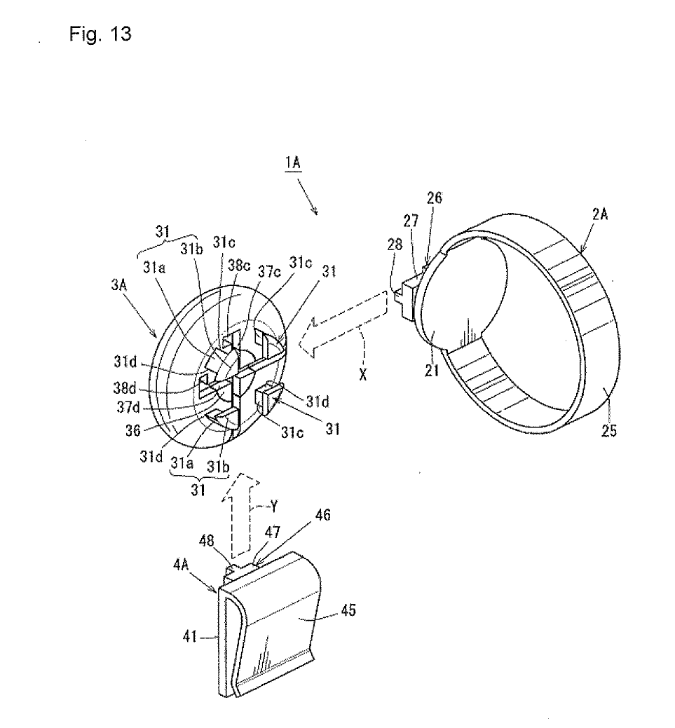

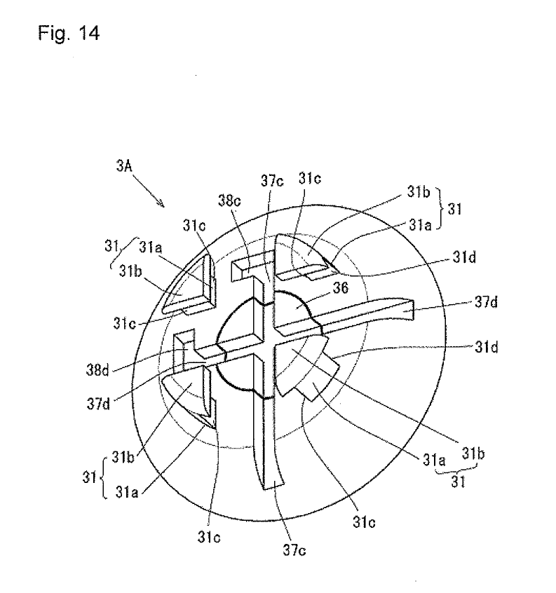

FIG. 12 shows an exploded perspective view of the exercise amount meter 1A seen from the front surface side, FIG. 13 shows an exploded perspective view of the exercise amount meter 1A seen from the rear surface side, and FIG. 14 is an enlarged perspective view of an exercise amount meter main body 3A seen from the rear surface side.

The exercise amount meter 1A is configured by the exercise amount meter main body 3A, and a belt type attachment body 2A and a clip type attachment body 4A that can be attached or detached to the exercise amount meter main body 3A.

As shown in FIG. 14, in the exercise amount meter main body 3A, a band groove 37d long in the left and right direction and a clip groove 37c long in the up and down direction are arranged in orthogonal at the rear surface.

The clip groove 37c extends in one line from the lower end of the exercise amount meter main body 3 to the upper side through the center. The upper end of the clip groove 37c includes a fixed groove 38c bent 90° to the left side in rear view to communicate with the clip groove 37c. The clip groove 37c and the fixed groove 38c form an L-shaped groove.

The band groove 37d extends in one line from the right end in rear view of the exercise amount meter main body 3 to the left side in rear view through the center. The left end in rear view of the band groove 37d includes a fixed groove 38d that is bent 90° to the upper side to communicate with the band groove 37d. The band groove 37d and the fixed groove 38d form an L-shaped groove.

The configuration of the exercise amount meter main body 3A is the same as the first example, and thus the same reference numerals are denoted to the same constituent elements, and detailed description thereof will be omitted.

As shown in FIG. 12, the belt type attachment body 2A includes an attachment/detachment engaging portion 26 on the surface on the outer side of the mount portion 21. The attachment/detachment engaging portion 26 is configured by a quadrangular prism shaped supporting column 29 having the center of the mount portion 21 fixedly attached to one side, a flange 27 fixedly attached to the other side in the supporting column 29, and an attachment body side projection 28 arranged on a surface on the outer side of the flange 27.

The flange 27 is a plate shape having a constant thickness, where guide rails 27d, 27d long in the attachment and detachment direction (direction of arrow X in FIG. 12) are arranged on both upper and lower ends in the width direction of the attachment and detachment direction. The guide rails 27d, 27d are parallel to each other, and are configured to be guided by the band guide recesses 31d, 31d shown in FIG. 13 to smoothly slidably move. The length of each guide rail 27d is configured to be slightly shorter than the spaced distance between the clip guide recesses 31c, 31c, and both ends of the guide rail 27d are guided by the clip guide recesses 31c, 31c to slidably move in the fixing direction (upper side in the figure).

The attachment body side projection 28 is arranged at one end of the flange 27. The attachment body side projection 28 is configured to be slightly smaller than the groove width of the band groove 37d and the fixed groove 38d so as to move in the groove of the band groove 37d and the fixed groove 38d.

The supporting column 29 is configured to be smaller than the spaced distance between the distal ends 31b, 31b of the attachment/detachment guide 31 of the exercise amount meter main body 3A. The supporting column 29 thus can move between the distal ends 31b, 31b.

Other configurations of the belt type attachment body 2A are the same as the first example, and thus the same reference numerals are denoted for the same constituent elements and the description thereof will be omitted.

As shown in FIG. 12, the clip type attachment body 4A includes an attachment/detachment engaging portion 46 on the surface on the outer side of the mount portion 41. The attachment/detachment engaging portion 46 is configured by a quadrangular prism shaped supporting column 49 having the center of the mount portion 41 fixedly attached to one side, a flange 47 fixedly attached to the other side in the supporting column 49, and an attachment body side projection 48 arranged on a surface on the outer side of the flange 47.

Since the configuration of the attachment/detachment engaging portion 46 is in the same shape as the attachment/detachment engaging portion 26 of the belt type attachment body 2A described above, and is arranged in the clip type attachment body 4A while being directed in the direction rotated 90 degrees, the detailed description thereof will be omitted.

Since other configurations of the clip type attachment body 4A are the same as the first example, the same reference numerals are denoted for the same constituent elements and the detailed description thereof will be omitted.

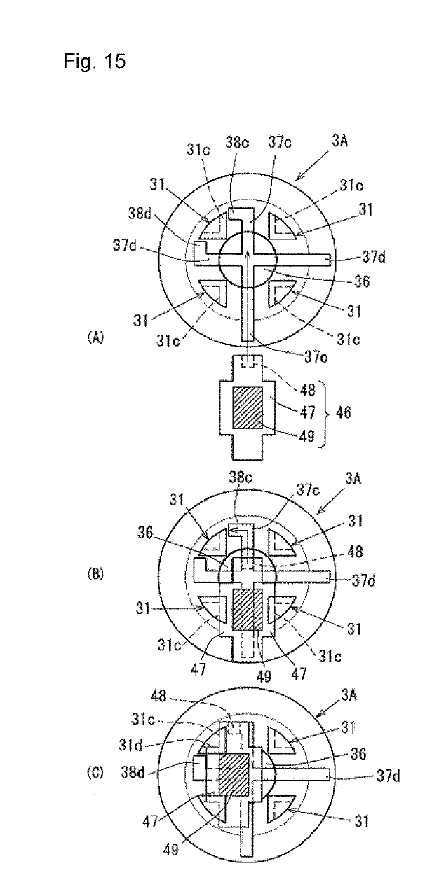

FIGS. 15(A) to 15(C) are explanatory views for describing the attachment/detachment operation of the clip type attachment body 4A in the exercise amount meter 1A configured as above.

When attaching the clip type attachment body 4A to the exercise amount meter main body 3A, the attachment body side projection 48 fits the attachment/detachment engaging portion 46 so as to slide in the clip groove 37c, as shown with an arrow of chain dashed line in FIG. 15(A).

As shown in FIG. 15(B), the flange 47 fits between the clip guide recesses 31c, 31c in the middle, and thereafter slidably moves stably. In this case, the flange 47 is sandwiched between the distal end 31b and the rear surface of the exercise amount meter main body 3 so as to slidably move stably.

When further slidably moved, the attachment body side projection 48 of the flange 47 collides with the upper end of the clip groove 37c.

When the flange 47 is moved to the left side in rear view as shown in FIG. 15(C), the attachment body side projection 48 slidably moves in the fixed groove 38c and collides with the left end in rear view of the fixed groove 38c. In this case, the guide rail 47c on the left side in rear view of the flange 47 engages with the band guide recesses 31d, 31d to which the guide rail 27d of the flange 27 of the belt type attachment body 2A engages, and slidably moves.

When detaching the attached clip type attachment body 4A from the exercise amount meter main body 3A, the clip type attachment body 4A is moved opposite to when attaching and then detached. In this case, the attachment body side projection 48 collides with the side wall of the clip groove 37c when the flange 47 is moved to the right in rear view, and thereafter, the flange 47 is slidably moved to the lower side to be detached.

The movement of attaching or detaching the belt type attachment body 2A to or from the exercise amount meter main body 3A is merely different in the direction of the movement, and others are similar operations.

When moved in such a manner, the attachment and detachment of the belt type attachment body 2A and the clip type attachment body 4A can be detected in the following manner.

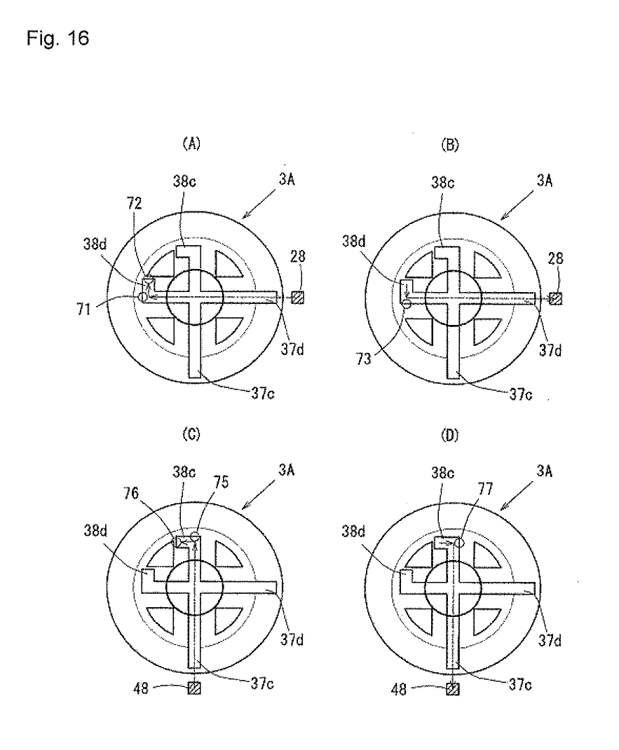

This will be described using the explanatory view showing the rear surface of FIGS. 16(A) to 16(D).

As shown in FIG. 16(A), when attaching the belt type attachment body 2A, the attachment body side projection 28 moves in the clip groove 37d to collide with the collision place 71 at the left end in the figure, and further moves in the fixed groove 38d to collide with the collision place 72 at the upper end in the figure.

Therefore, the acceleration detection unit 12 can detect the collision of a total of two times, the collision to the left side in the figure (right side when viewed from the front surface of the exercise amount meter 1A) and the collision to the upper side in the figure, so that the attachment of the belt type attachment body 2 can be recognized.

The acceleration detection unit 12 may be configured to detect only the collision to the left side, and recognize that the belt type attachment body 2A is attached. In this case, the threshold value of the collision intensity to detect may be set to distinguish the collision at the collision place 76 at the left end in the figure when attaching the clip type attachment body 4A shown in FIG. 16(C).

The fixed groove 38c shown in FIG. 16(C) may be formed slightly narrow so that the projection 28 fits in the fixed groove 38c, so that the collision at the collision place 76 does not occur. in this case, there can be adopted a configuration of recognizing the attachment of the belt type attachment body 2A if the collision is to the left side in the figure.

As shown in FIG. 16(B), when detaching the belt type attachment body 2A, the attachment body side projection 28 moves in the fixed groove 38d and collides with the collision place 73 at the lower end in the figure.

Therefore, the acceleration detection unit 12 can detect the collision to the lower side in the figure, and thus can recognize that the belt type attachment body 2A is detached.

As shown in FIG. 16(C), when attaching the clip type attachment body 4A, the attachment body side projection 48 moves in the band groove 37c and collides with the collision place 75 at the upper end in the figure, and also moves in the fixed groove 38c and collides with the collision place 76 at the left end in the figure.

Therefore, the acceleration detection unit 12 can detect the collision of a total of two times, the collision to the upper side and the collision to the left side in the figure (right side when viewed from the front surface of the exercise amount meter 1A), so that the attachment of the clip type attachment body 4A can be recognized.

The acceleration detection unit 12 may be configured to detect only the collision to the upper side, and recognize that the clip type attachment body 4A is attached. In this case, the threshold value of the collision intensity to be detected may be set to distinguish the collision at the collision place 72 at the upper end in the figure when attaching the belt type attachment body 2A shown in FIG. 16(A).

The fixed groove 38d shown in FIG. 16(A) may be formed slightly narrow so that the projection 28 fits in the fixed groove 38d, so that the collision at the collision place 72 does not occur. In this case, there can be adopted a configuration of recognizing the attachment of the clip type attachment body 4A if the collision is to the upper side in the figure.

As shown in FIG. 16(D), when detaching the clip type attachment body 4A, the attachment body side projection 48 moves through, the fixed groove 38c and collides with the collision place 77 at the left end of the figure.

Therefore, the acceleration detection unit 12 can detect the collision to the right side of the figure (left side when viewed from the front surface of the exercise amount meter 1A) and recognize that the clip type attachment body 4A has been detached.

Since the operations other than detecting the attachment and detachment are the same as the first example, the detailed description thereof will be omitted. In other words, the detection of attachment and detachment and the detection on whether or not the attachment direction of steps S2, S3, S9, S10 described in the first example are changed to the detection method described above, and others are the same as the first example.

The effects same as the first example can be obtained by the above configuration and operation as well. In the second example, an appropriate configuration such as a configuration in which the attachment body side projection 28, 48 is moved through the fixed groove 38c or the fixed groove 38d so as to be securely fitted and fixed while filling the gap when attaching the belt type attachment body 2A or the clip type attachment body 4A, or a configuration of being fitted to an appropriate bump and position fixed may be adopted. The belt type attachment body 2A and the clip type attachment body 4A thus can be prevented from being unintentionally detached from the exercise amount meter main body 3A.

In the second example, the attachment/detachment engaging portions 26, 46 are moved at 90° right angle, but the flanges 27, 47 may be linearly moved and only the attachment body side projections 28, 48 may be moved alone in the right angle direction. In this case as well, two collisions in different directions can be detected at the time of attachment, and one collision can be detected at the time of detachment, and hence which of the belt type attachment body 2A and the clip type attachment body 4A is attached or detached, and whether attachment or detachment can be detected.

The exercise amount meters 1, 1A described in the first and second examples may include a communication unit. The communication unit may be configured by an appropriate communication interface such as a wire connecting USB (Universal Serial Bus) or a wireless communicating Bluetooth (registered trademark).

The communication with an information processing device such as a personal computer, a portable telephone, or a PDA (Personal Digital Assistants) then can be realized.

In this case, the operation unit 17 may be configured to perform the data transmission operation of transmitting data to a separate information processing terminal connected to the communication unit.

In the first and second examples, three modes of the waist attachment mode, the arm attachment mode, and the pocket-in mode are provided, but the mode is not limited thereto and may be other modes. In this case as well, the current attachment or detachment state can be reliably measured by corresponding the respective mode and the attachment/detachment detection.

In the correspondence of the configuration of the present invention and the embodiment described above,
an attachment body of the present invention corresponds to the belt type attachment body 2 and the clip type attachment body 4 of the embodiment; and similarly,
a body motion detection device and a device main body correspond to the exercise amount meter main body 3;
acceleration detection means corresponds to the acceleration detection unit 12;
display means corresponds to the display unit 13;
a screen corresponding to the mode corresponds to the arm attachment mode display screen 13a, the waist attachment mode display screen 13b, and the pocket-in mode display screen 13c;
calculation means corresponds to the calculation unit 14;
storage means corresponds to the storage unit 16;
one part of the attachment body corresponds to the rib 23, 43 and the attachment body side projection 28, 48;
an attachment/detachment portion and guide correspond to the attachment/detachment guide 31;
a collision body corresponds to the collision projection 33, the clip groove 37c and the fixed groove 38c, and the band groove 37d and the fixed groove 38d;
an attachment/detachment detection process corresponds to steps S2, S3, S9, S10;
a body motion calculating process corresponds to steps S21 to S26, S31 to S36, S41 to S43;
a living body corresponds to a user;
a living body associated article corresponds to the belt, pants, or skirt of the user;
a mode corresponds to the arm attachment mode, the waist attachment mode, and the pocket-in mode; and
the body motion corresponds to the number of steps, the life activity amount, and the arm swing level; but
the present invention is not limited to the configuration of the embodiment described above, and many other embodiments may be obtained.

### INDUSTRIAL APPLICABILITY

The present invention can be used in an exercise amount meter for detecting the exercise amount of the user such as a pedometer or a life activity amount meter.

### DESCRIPTION OF SYMBOLS

2, 2A belt type attachment body

3, 3A exercise amount meter main body

4, 4A clip type attachment body

12 acceleration detection unit

13 display unit

13a arm attachment mode display screen

13b waist attachment mode display screen

13c pocket-in mode display screen

14 calculation unit

16 storage unit

23, 43 rib

28, 48 attachment body side projection

31, 31E attachment/detachment guide

33 collision projection

37c, 38c clip groove

37d, 38d fixed groove

1. A body motion detection device comprising:
acceleration detection means for detecting acceleration; and
calculation means for executing a body motion calculating process of calculating the body motion of a living body based on acceleration data detected by the acceleration detection means, the body motion detection device comprising:
an attachment/detachment portion for allowing an attachment body to be attached to the living body or a living body associated article to be attached or detached to or from a device main body, wherein
the calculation means is configured to execute an attachment/detachment detection process of detecting attachment or detachment from change in acceleration appearing in the acceleration data when attaching or detaching the attachment body to or from the attachment/detachment portion, and execute the body motion calculating process based on the detected attachment/detachment while switching to a mode complying with a state after the attachment/detachment.

2. The body motion detection device according to claim 1, wherein
the attachment/detachment portion includes a collision body to which one part of the attachment body collides in the attachment or detachment of the attachment body; and
the attachment/detachment detection process is configured to detect the change in acceleration that appears when one part of the attachment body collides with the collision body from the acceleration data.

3. The body motion detection device according to claim 2, wherein
a plurality of the attachment/detachment portion are respectively arranged in correspondence with each of a plurality of types of attachment bodies.

4. The body motion detection device according to claim 3, wherein
the attachment/detachment detection process detects the type of attached or detached attachment body by a direction of the change in acceleration that appears when one part of the attachment body collides with the collision body.

5. The body motion detection device according to claim 3, wherein
the attachment/detachment portion is configured by differing the number of collision bodies according to the type of the corresponding attachment body; and
the attachment/detachment detection process is configured to detect the type of attached or detached attachment body by the number of change in acceleration that appears when one part of the attachment body collides with the collision body.

6. A body motion detection device comprising:
acceleration detection means for detecting acceleration;
storage means for storing data;
calculation means for executing a body motion calculating process of calculating the body motion of a living body based on acceleration data detected by the acceleration detection means; and
display means for displaying the calculation result, the body motion detection device comprising:
a plurality of attachment/detachment portions for allowing an attachment body to be attached to the living body or a living body associated article to be attached or detached to or from a device main body according to a type of attachment body; wherein
the calculation means is configured to
execute an attachment/detachment detection process of detecting attachment and detachment of the attachment body with respect to the attachment/detachment portion and the type of attachment body from change in acceleration that appears in the acceleration data when the attachment body is attached or detached with respect to the attachment/detachment portion, and
execute the body motion calculating process based on the detected attachment/detachment and the type while switching to a mode corresponding to the type of attachment body being attached; and
the display means is configured to display a screen corresponding to the mode.

7. A body motion detection device for detecting body motion of a living body comprising an attachment/detachment portion for allowing an attachment body to be attached to the living body or a living body associated article to be attached or detached to or from a device main body, wherein
the attachment/detachment portion includes
a guide for sliding or rotating the attachment body when the attachment body is attached or detached to or from the device main body, and
a collision portion to which one part of the attachment body collides in the attachment or detachment of the attachment body along the guide.

8. An input device comprising:
acceleration detection means for detecting acceleration;
calculation means for executing a calculation based on the acceleration data detected by the acceleration detection means, and
a housing for accommodating the acceleration detection means and the calculation means, wherein
the housing includes a collision body to be applied with an impact by collision; and
the calculation means is configured to
detect impact acceleration data in which change in acceleration occurs by the impact applied on the collision body from the acceleration data,
detect impact content in which the impact is applied from the acceleration data, and
execute an input information determining process of determining the information inputted by the impact content.

9. A body motion detection method of detecting body motion of a living body from acceleration data indicating change in acceleration caused by the body motion of the living body, the body motion detection method comprising the steps of:
detecting change in acceleration that occurs when an attachment body is attached or detached with respect to a device main body from the acceleration data; and
detecting the body motion from the acceleration data of after attachment or detachment by a body motion detection process of a mode corresponding to a state after the attachment or detachment.
